(19) United States
(12) Patent Application Publication
(10) Pub. No.: US 2023/0267425 A1
(43) Pub. Date: Aug. 24, 2023

(54) System, Method, and Apparatus for Mobile Vehicle Service

(71) Applicant: Mobile Next Level, LLC, Palm Harbor, FL (US)

(72) Inventor: John Schmidt, Palm Harbor, FL (US)

(21) Appl. No.: 18/171,703

(22) Filed: Feb. 21, 2023

Related U.S. Application Data
(60) Provisional application No. 63/313,312, filed on Feb. 24, 2022.

(51) Int. Cl. G06Q 10/20; G06Q 10/0631

(52) U.S. Cl. CPC G06Q 10/20; G06Q 10/063112; G06Q 10/06314

(57) ABSTRACT

A remote service system includes software that is easily customized to the service center(s) and provides administration and operations to the service center personnel as well as to clients of the service center. The software administratively adjusts to the names, logos, color-schemes, and parameters of the service center to provide remote service scheduling and tracking to employees and clients. Once administered, the software presents user interfaces to automatically schedule the desired remote services based upon geographical constraints, staffing, and resources. The software then optimizes use of resources (e.g., technicians, drivers, trucks) and routing to provide services to clients in an efficient manner. The software reports status of the remote service calls, billed hours, utilizations, etc., allowing management to understand the value of remote services to the service center.

### CROSS-REFERENCE TO RELATED APPLICATIONS

This application is a non-provisional patent application taking priority from U.S. Provisional Patent Application No. 63/313,312 filed Feb. 24, 2022.

### FIELD OF THE INVENTION

This invention relates to the field of vehicular service and more particularly to a system for scheduling and routing remote service technicians or drivers.

### BACKGROUND OF THE INVENTION

In the past, when a vehicle requires servicing, the vehicle was transported to a service center (e.g., automobile dealership) where the service is performed (e.g., oil change, tune-up, tire rotation). As vehicle owners are geographically disbursed, obtaining such service requires the owner to drive their vehicle several miles out of their way, then sit in a waiting room while the service is performed, then drive back or drive to their next desired location. Although service centers often have night and weekend hours, it is often difficult to make such appointments and, therefore, difficult for those with full-time jobs to obtain the required services. Further, most people do not enjoy sitting in a waiting room for an hour or two while the service is being performed, especially in recent years in which many might fear biological contamination from others waiting in the same room.

In recent years, service centers have initiated remote service operations for certain routine services such as tire rotation and oil changes. In this, the owner calls the service center and speaks with a call taker who uses a calendar to schedule service at the desired location (e.g., owner's home or place of work). For example, the call taker schedules the requested vehicle service at 9:00 AM at the location of the owner's work. From the perspective of the owner, this type of service is a vast improvement over driving to the service center and waiting for the service to be finished or borrowing a loaner-car, etc. Further, there may be a savings in fuel consumption if the technician drives less miles between owner locations than would be required if the owners all drove to the service centers. Unfortunately, the typical call taker has no tools for optimizing the travels of the remote technician/driver and has limited abilities to ascertain required details as whether there is ample level space for the service that will be performed. Further, the call taker has no tools or abilities to make schedule arrangements that optimize the travel of the technician. All of this results in vastly underutilized remote service resources (e.g., technicians, drivers, trucks, tools) and lower than desired revenues. In some service centers, a driver is sent to pickup the vehicle and return the vehicle to the service center where the service is performed.

What is needed is a system that will automate remote service operations in a systematic way and overcome the above noted setbacks.

### SUMMARY OF THE INVENTION

A remote service system includes software that is easily customized to the service center(s), providing administration and operations to the service center personnel as well as to clients of the service center. The software administratively adjusts the names, logos, color-schemes, and parameters of the service center to provide remote service scheduling and tracking capabilities to employees and clients. Once administered, the software presents user interfaces to automatically schedule the desired remote services based upon geographical constraints, staffing, and resources. The software then optimizes use of resources (e.g., technicians, drivers, trucks) and routing to provide remote services to clients in an efficient manner. The software reports status of the remote service calls, billed hours, utilizations, etc., allowing management to understand the value of remote services to the service center.

In one embodiment, a method of providing remote services is disclosed including (a) determining a set of vehicles to be serviced within a timeslot and within a zone of locations, (b) analyzing a location of each vehicle in the set of vehicles to determine a next vehicle in the set of vehicles to be serviced and a set of services to be performed on the next vehicle, (c) selecting an available mobile technician from a set of mobile technicians, (d) establishing a data connection to a mobile technician device that is assigned to the available mobile technician and communicating with the mobile technician device to dispatch the available mobile technician to the next vehicle to perform the set of services at the location of the next vehicle, (e) removing the next vehicle from the set of vehicles to be serviced in the timeslot; and (f) until all vehicles in the set of vehicles to be serviced have been assigned to one of the available mobile technician, repeating steps b-e.

In another embodiment, a system for providing remote service for vehicles is disclosed including a server computer that is connected to a data network and is configured with at least one timeslot and zone of locations pair. There are a several mobile technician devices, each assigned to a mobile technician/driver and each connected to the server computer through the data network. There are several owner devices, each owner devices selectively connects to the server computer through the data network. The server computer receives a plurality of remote service requests from the plurality of owner devices, each request including a location of a vehicle to be serviced that includes a zip code, and each request including a timeslot. Before each timeslot and zone of locations pair, and until all remote service requests for that timeslot are dispatched, the server computer assigning a next remote service request in that timeslot and zone of locations pair to a mobile technician/driver and the server computer sending details of the next remote service request to a mobile technician device assigned to the mobile technician/driver through the data network. After receiving the details of the next remote service request, the mobile technician/driver visiting the location of the vehicle for remote services and the mobile technician/driver performing services included in the next remote service request (e.g., performing mobile services and/or transporting the vehicle to a service center.

In another embodiment, a computer-readable storage medium storing instructions that, when executed by a server computer, cause the server computer to perform a process that includes establishing, via one or more network interfaces, a first communication channel between the server computer and one or more owner devices and receiving a remote service request from each of the one or more owner devices, combining all remote service requests for a timeslot and zone; and for each remote service request for the timeslot and the zone: establishing, via the one or more network interfaces, a communication channel between the server computer and a mobile technician device, and sending the each remote service request for the timeslot and the zone to the mobile technician device.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a data connection diagram of system for providing remote services.

FIG. 2 illustrates a schematic view of a mobile technician device of the system for providing remote services.

FIG. 3 illustrates a schematic view of a typical computer system.

FIGS. 4 through 11 illustrate service center customization user interfaces of the system for providing remote services.

FIGS. 12 through 19 illustrate service request user interfaces of the system for providing remote services.

FIGS. 20 through 23 illustrate administrative user interfaces of the system for providing remote services.

FIG. 24 illustrates an administration flow chart of a typical computer system.

FIG. 25 illustrates a scheduling flow chart of a typical computer system.

FIG. 26 illustrates a timeslot scheduling flow chart of a typical computer system.

FIG. 27 illustrates an exemplary division of zip codes into zones of the system for providing remote services.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

Throughout this description, the term “mobile technician” refers to a person who is able to perform the desired service at the location of the owner. The term “driver” refers to an employee designated to retrieve a vehicle from the client location and/or return the vehicle to the client location. The term “owner” refers to a person who owns or is responsible for the vehicle which will be serviced. Although the owner is often the person arranging for the remote service, it is fully anticipated that the remote service will be arranged by a relative of the owner, a co-worker of the owner, a friend of the owner, etc. The term “owner device” refers to a device used by the owner (or other person) to create a service request. The term “service center” refers to any home-base for the mobile technicians/drivers, though it is equally anticipated that the mobile technicians do not return to the service center except for restocking and properly disposing of waste material. In some instances, the service center is part of an automobile dealership as automobile dealerships often provide service to those who purchased vehicles at that dealership as well as other owners of vehicles. In some embodiments, drivers are dispatched to transport the vehicle to the service center for repairs/maintenance, then after the work is completed, transport the vehicle back to the client.

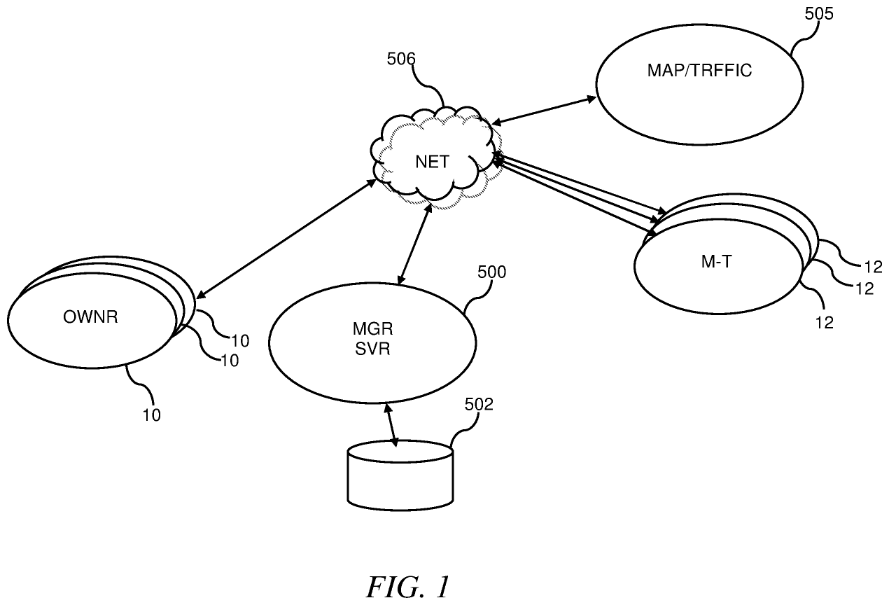

Referring to FIG. 1, a data connection diagrams of the exemplary system for providing remote services is shown. In this example, owner devices 10 (e.g., personal computers, smartphones) communicate through a data network 506 (e.g., the Internet, local area networks, etc.) to a remote services computer system 500. The owner devices 10 are presented with user interfaces as will be described for scheduling remote services for their vehicles.

The remote services computer system 500 (e.g., a computer, a server or an array of servers or computers) provides the user interfaces, receives scheduling requests, stores scheduling information, schedules and dispatches mobile technicians to perform the services or driver(s) to transport the vehicle to the service center where the work is performed, then the vehicle is transported back to the client. Note that the remote services computer system 500 is anticipated to maintain and operate the remote service calls for several service centers (e.g., vehicle dealers) through administration of each service center including color scheme, names, logos, and service preferences such as timeslots and types of services to be performed.

The remote services computer system 500 has access to data storage 502 for storing data regarding each service center, data per each mobile technician/driver, timeslots, appointments, etc. In some embodiments, the system for providing remote services accesses map and traffic 505 from a map and traffic service provider for optimizing a schedule within each timeslot for the mobile technician/driver. The remote services computer system 500 communicates with each active mobile technician device 12 to inform each mobile technician/driver where the next service will be and what services are to be performed, etc.

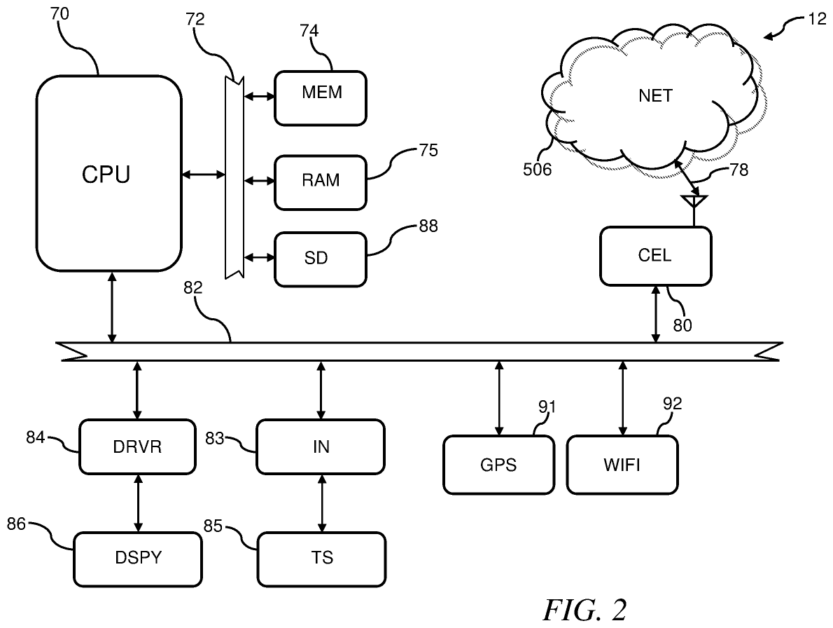

Referring to FIG. 2, a schematic view of an exemplary mobile technician device 12 is shown as used in the system for providing remote services. The exemplary mobile technician device 12 is a processor-based device for providing voice recognition and command execution, for example, a smartphone or tablet computer. The present invention is in no way limited to any particular mobile technician device 12 and many other devices are anticipated. The same mobile technician device 12 is also used by the drivers.

The exemplary mobile technician device 12 represents a typical device used for accessing user interfaces of the system for providing remote services. This exemplary mobile technician device 12 is shown in its simplest form. Different architectures are known that accomplish similar results in a similar fashion, and the present invention is not limited in any way to any particular system architecture or implementation. In this exemplary mobile technician device 12, a processor 70 executes or runs programs in a random-access memory 75. The programs are generally stored within a persistent memory 74 and loaded into the random-access memory 75 when needed. In some mobile technician devices 12, a removable storage 88 (e.g., compact flash, SD) offers removable persistent storage. The processor 70 is any processor, typically a processor designed for phones. The persistent memory 74, random-access memory 75, and removable storage slot are connected to the processor by, for example, a memory bus 72. The random-access memory 75 is any memory suitable for connection and operation with the selected processor 70, such as SRAM, DRAM, SDRAM, RDRAM, DDR, DDR-2, etc. The persistent memory 74 is any type, configuration, capacity of memory suitable for persistently storing data, for example, flash memory, read only memory, battery-backed memory, etc. In some agent computers 10, the persistent memory 74 is removable, in the form of a memory card of appropriate format such as SD (secure digital) cards, micro-SD cards, compact flash, etc.

Also connected to the processor 70 is a system bus 82 for connecting to peripheral subsystems such as a wireless network interface 80 (e.g., Cellular or Wi-Fi), a display driver 84 for driving a display device 86, and an input port 83 for reading touch inputs from a touch screen interface 85, though there is no restriction on types and configurations of inputs and outputs.

In general, some portion of the persistent memory 74 and/or the removable storage 88 is used to store executable code, and data, etc.

The peripherals are examples, and other devices are known in the industry such as Global Positioning Subsystems 91, the details of which are not shown for brevity and clarity reasons.

The wireless network interface 80 connects the exemplary mobile technician device 12 to the data network 506 through any known or future protocol such as Ethernet, WI-FI, GSM, TDMA, LTE, etc., through a wired or wireless medium 78. There is no limitation on the type of connection used. The wireless network interface 80 provides data and messaging connections between the exemplary mobile technician device 12 and the remote services computer system 500 through the data network 506.

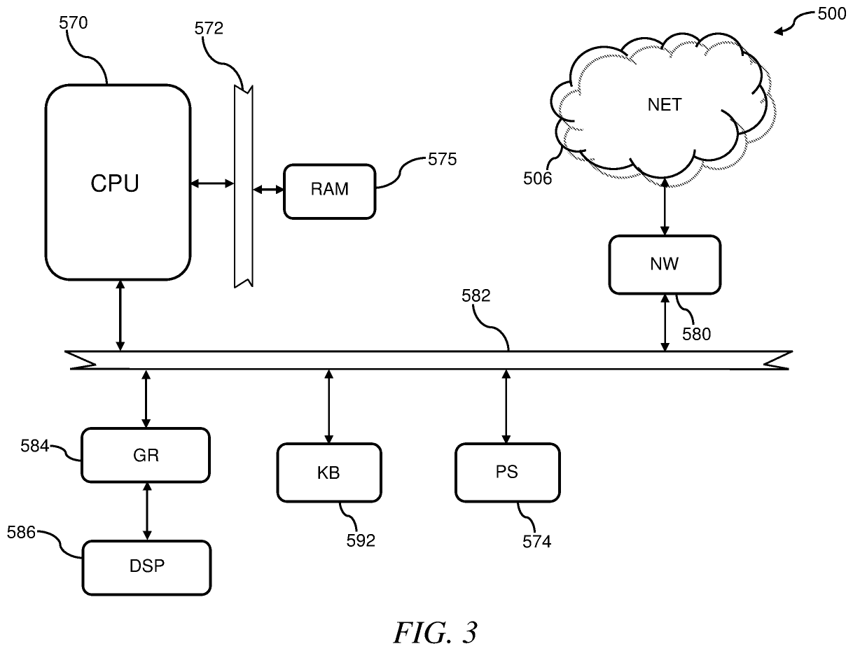

Referring to FIG. 3, a schematic view of a typical computer system used as the remote services computer system 500 (or in some embodiments as the owner device 10) is shown. The example server computer system represents a typical remote services computer system 500 used as in the system for operations. This exemplary remote services computer system 500 (or server) is shown in its simplest form. Different architectures are known that accomplish similar results in a similar fashion and the present invention is not limited in any way to any particular computer system architecture or implementation. In this exemplary remote services computer system 500, a processor 570 executes or runs programs in a random-access memory 575. The programs are generally stored within a persistent memory 574 and loaded into the random-access memory 575 when needed. The processor 570 is any processor, typically a processor designed for computer systems with any number of core processing elements, etc. The random-access memory 575 is connected to the processor by, for example, a memory bus 572. The random-access memory 575 is any memory suitable for connection and operation with the selected processor 570, such as SRAM, DRAM, SDRAM, RDRAM, DDR, DDR-2, etc. The persistent memory 574 is any type, configuration, capacity of memory suitable for persistently storing data, for example, magnetic storage, flash memory, read only memory, battery-backed memory, etc. The persistent memory 574 is typically interfaced to the processor 570 through a system bus 582, or any other interface as known in the industry.

Also shown connected to the system bus 582 is a network interface 580 (e.g., for connecting to a data network 506), a graphics adapter 584 and a keyboard interface 592 (e.g., Universal Serial Bus—USB). The graphics adapter 584 receives information from the processor 570 and controls what is depicted on a display 586. The keyboard interface 592 provides navigation, data entry, and selection features.

In general, some portion of the persistent memory 574 is used to store programs, executable code, data, contacts, and other data, etc.

The peripherals are examples and other devices are known in the industry such as pointing devices, touch-screen interfaces, speakers, microphones, USB interfaces, Bluetooth transceivers, Wi-Fi transceivers, image sensors, temperature sensors, etc., the details of which are not shown for brevity and clarity reasons.

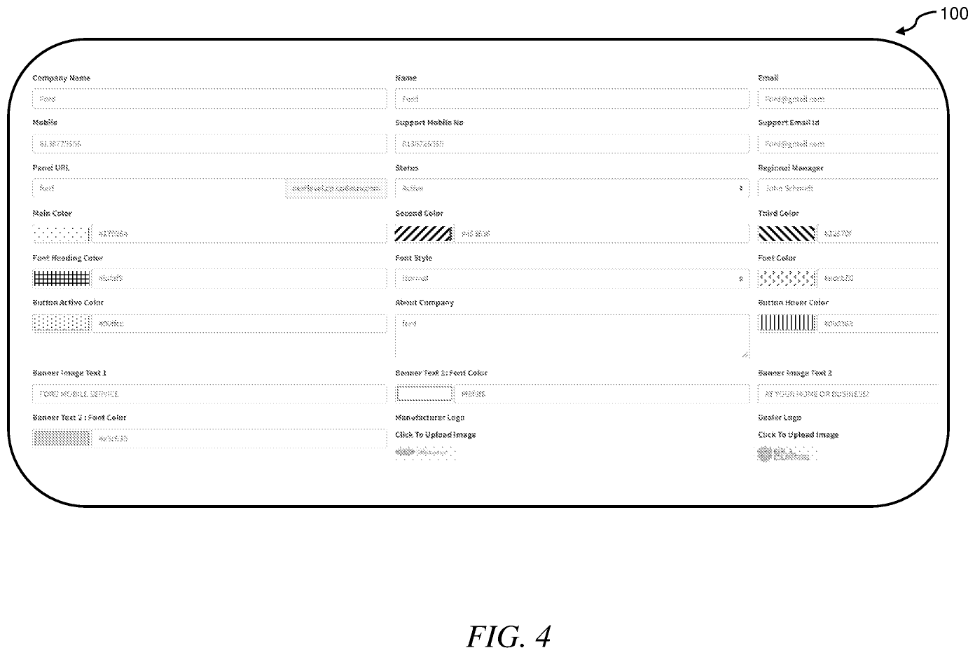

Referring to FIGS. 4 through 11, service center customization user interfaces 100, 120, 140, 160, 180, 200, 220 of the system for providing remote services are shown. The system for providing remote services is customizable so that users of the system for providing remote services feel that they are accessing user interfaces that represent the service center or dealership with which they are familiar. In this, the names, logos, addresses, phone numbers, color schemes, etc., of the service center or dealership are customized to look like that service center or dealership, In FIG. 4, the service center name, vehicle manufacturer logos, dealership logos, key staff, and color scheme are set.

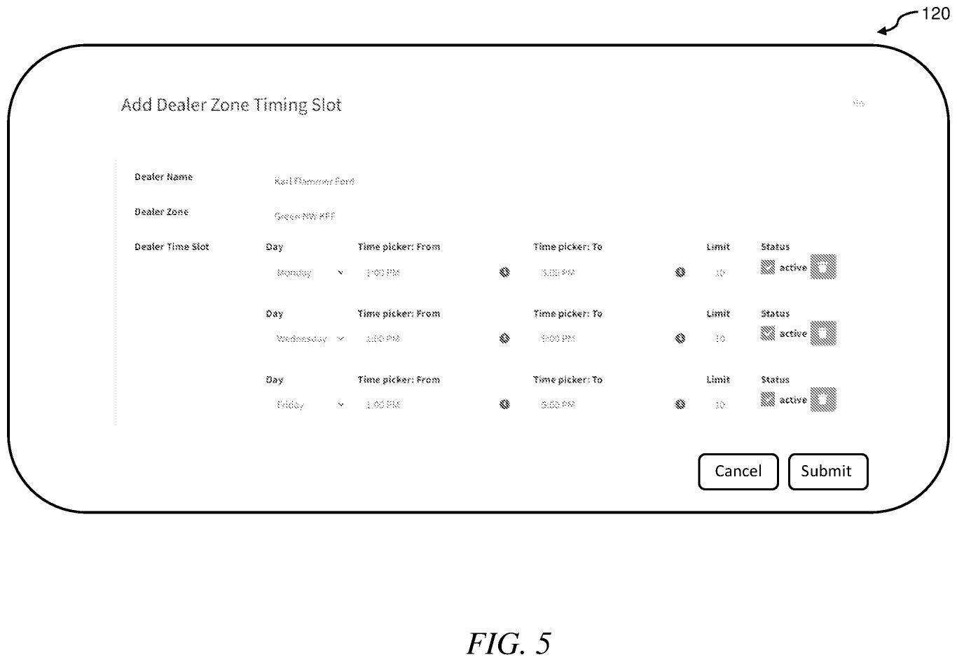

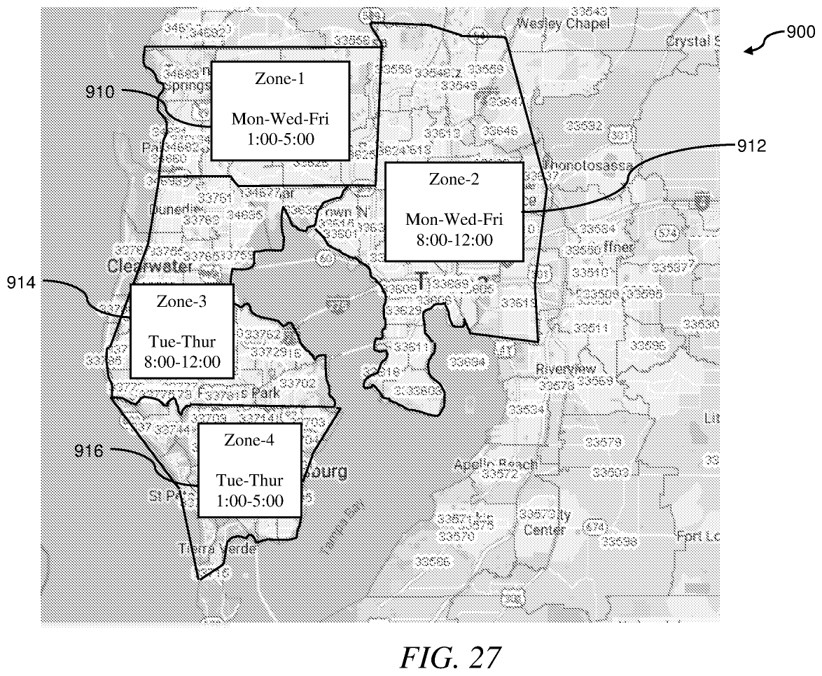

After the overall scheme is selected, details regarding service scheduling and locations are entered. Although not shown as a user interface, the dealer administers two or more zones/regions so that each zone includes one or more zip codes as shown pictorially in FIG. 27. In FIG. 5, one region of service or zone, is administered in the service times user interface 120. In this example, north-west Tampa. The service center is able to select what days of the week and what time ranges (timeslots) are available for service in that region. For example, remote service is available to this timeslot (or region) in three shifts on Mondays, one shift from 8:00 AM to 12:00 PM, another shift from 1:00 PM to 4:00 PM and a final shift from 5:00 PM to 9:00 PM. As an example, different regions/ones are configured for Tuesdays with the same or different shift ranges, maybe not having a 5:00 PM to 9:00 PM shift every day, etc.

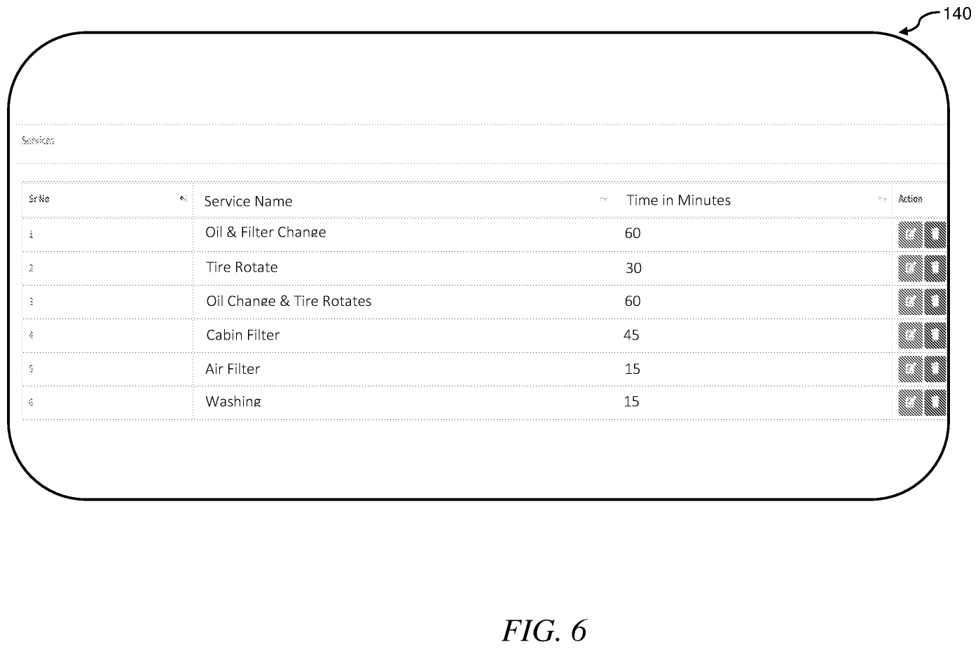

In FIG. 6, the types of service user interface 140 provides selections of which remote service is available. This provides selections for each service center to enable or disable the availability of each service. For example, one service center only provides oil changes and tire rotations while a different service center also provides for filter changes.

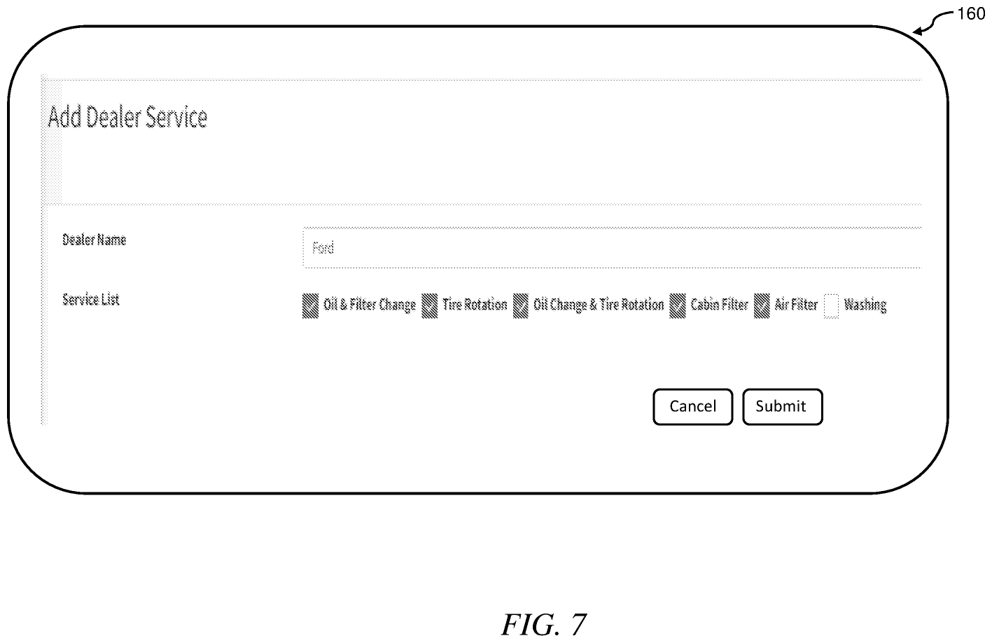

In FIG. 7, the selected types of service user interface 160 provides a linear list of selections of which remote service is available.

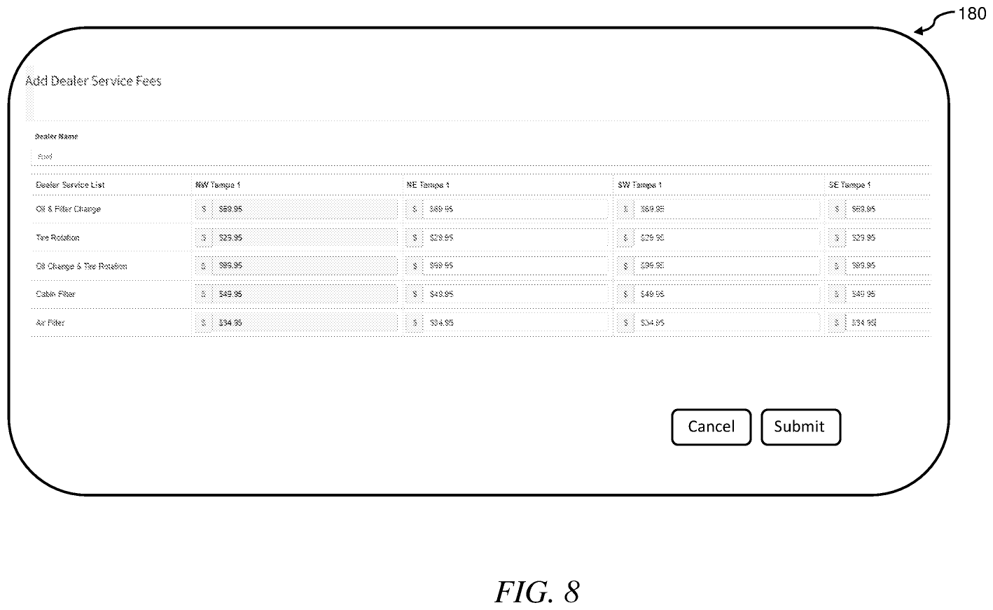

In FIG. 8, the cost-of-service user interface 180 provides fields for setting the cost of each remote service that is available, by service region. This provides for setting the cost structure of the selected remote service based upon the remote service regions. It is anticipated that the cost structure varies by service regions to compensate for added costs due to local regulations, tolls, congestion, parking issues, etc.

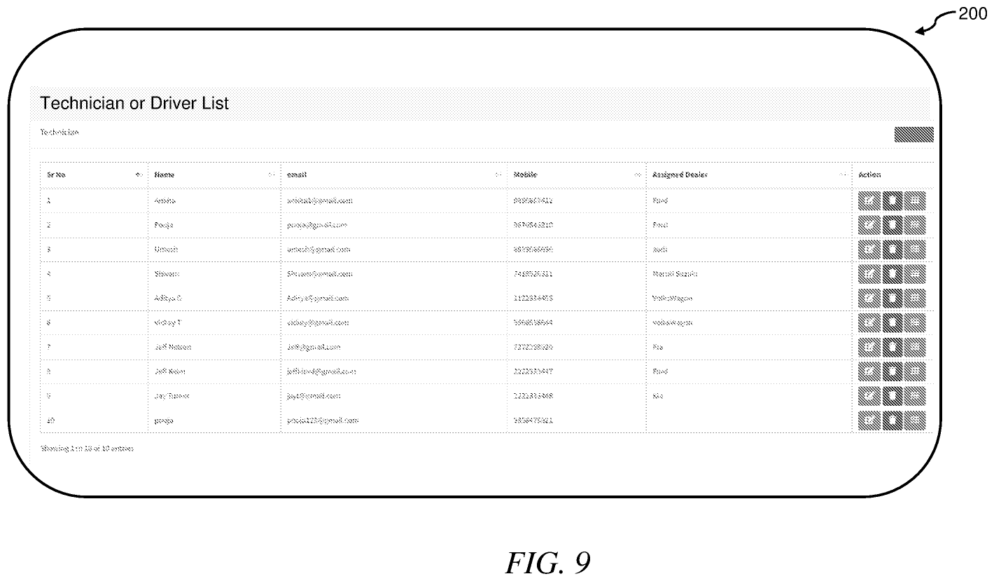

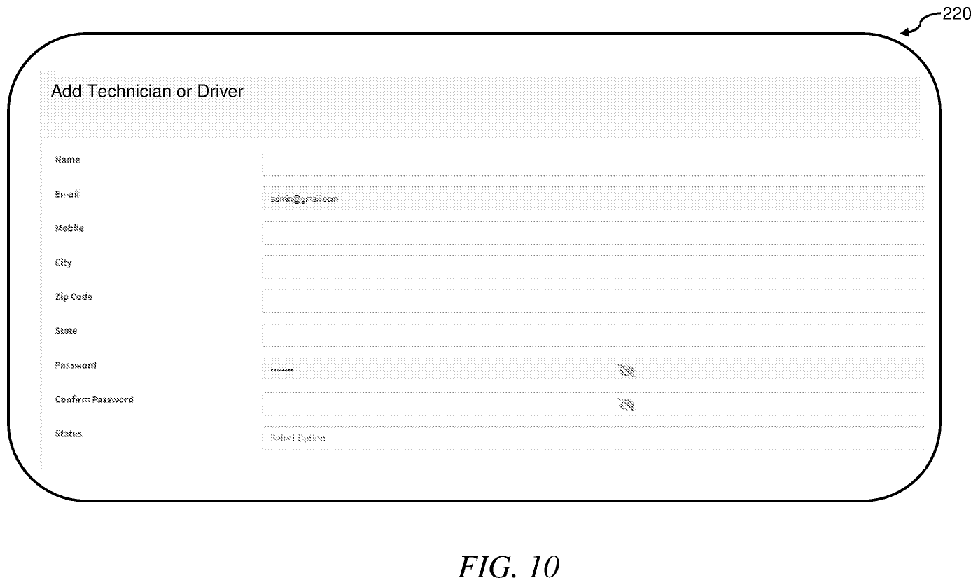

In FIG. 9, the mobile technician/driver master list user interface 200 provides a list and status of which mobile technicians/drivers are available, for example, a set of mobile technicians/drivers. This provides selections and views for each service center to update and monitor the availability of each mobile technician/driver. For example, changing the status of a mobile technician/driver when on vacation. In a related mobile technician/driver assignment user interface 220 of FIG. 10, a new mobile technician/driver is added including the mobile technician's or driver's name, email address, phone number, address, access password, and status (e.g., active, sick, vacation).

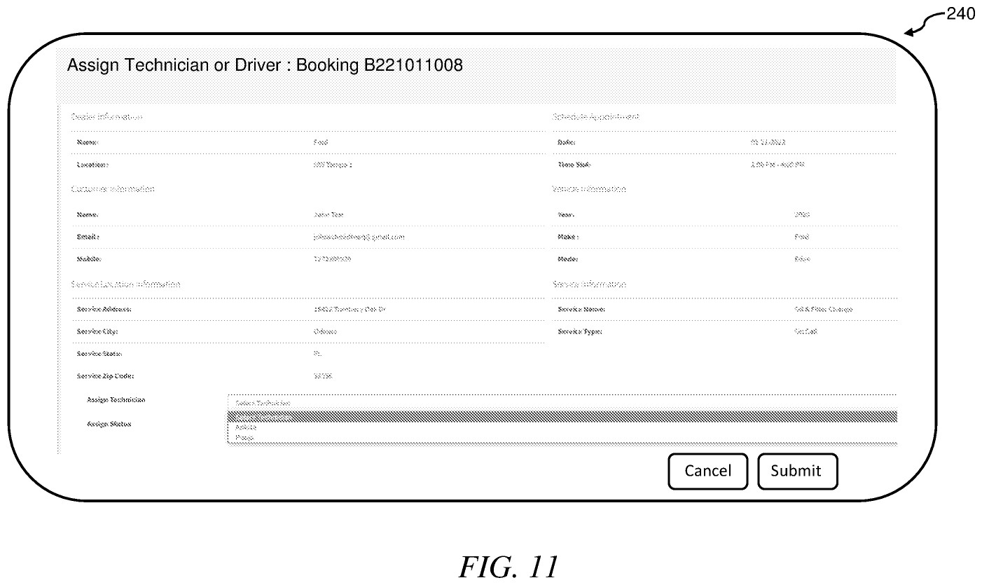

In FIG. 11, a mobile technician/driver assignment user interface 240 provides selections of a mobile technician/driver that is available to service a specific booking. The mobile technician/driver assignment user interface 220 shows details of the booking such as location and type of the vehicle, service desired, and a list of mobile technicians/drivers that are available to perform this service (two mobile technicians/drivers are shown in this example).

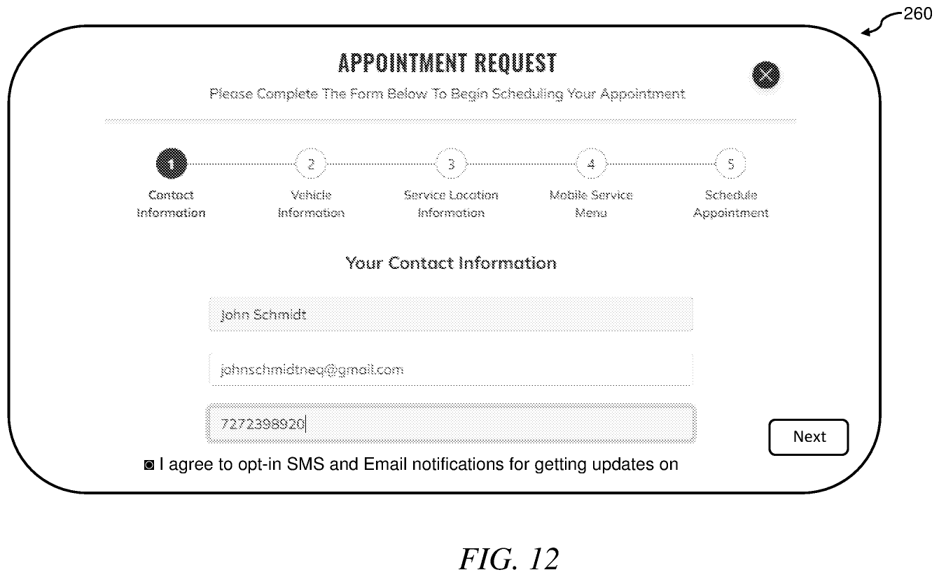

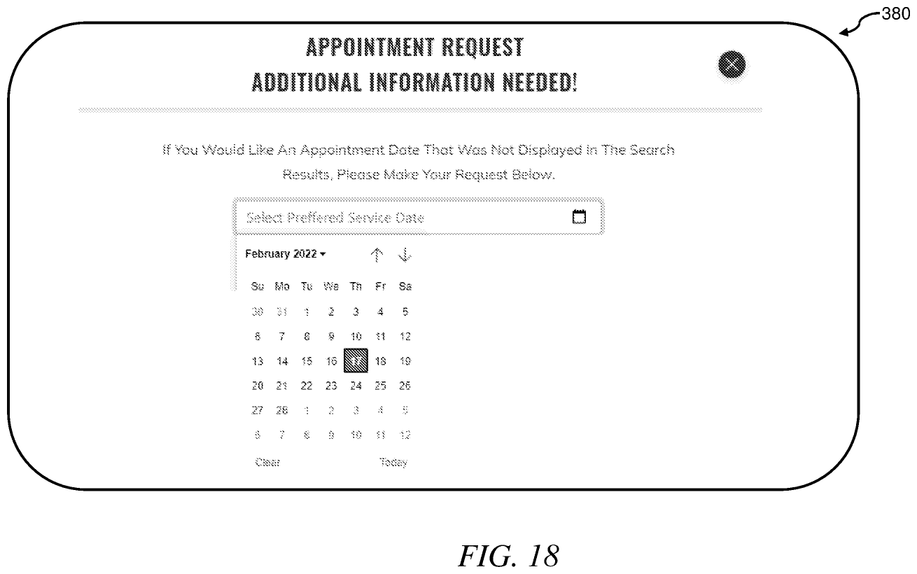

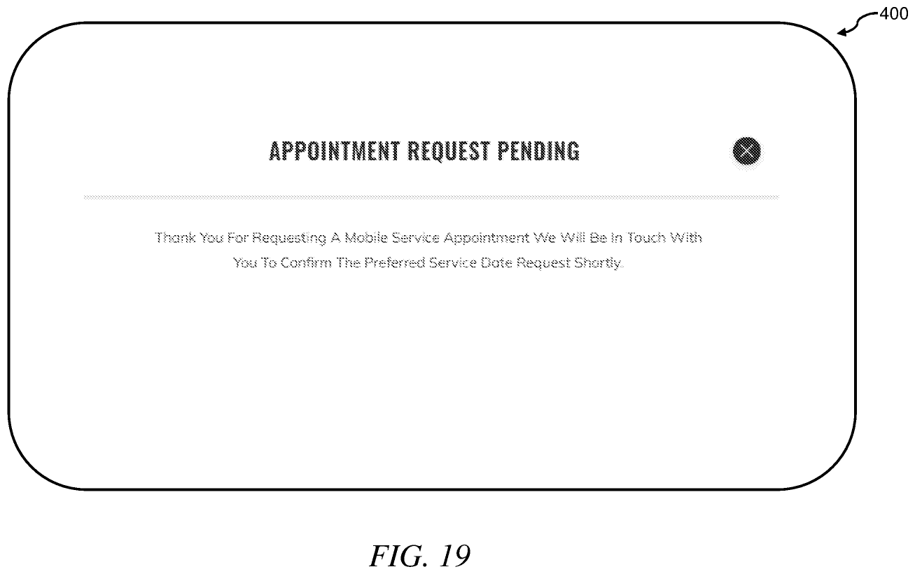

Referring to FIGS. 12 through 19, service request user interfaces 260, 280, 300, 320, 340, 360, 380 and 400 of the system for providing remote services are shown.

In FIG. 12, a first remote service request user interface 260 provides for the owner (or representative) to enter contact information such as an email address and a phone number.

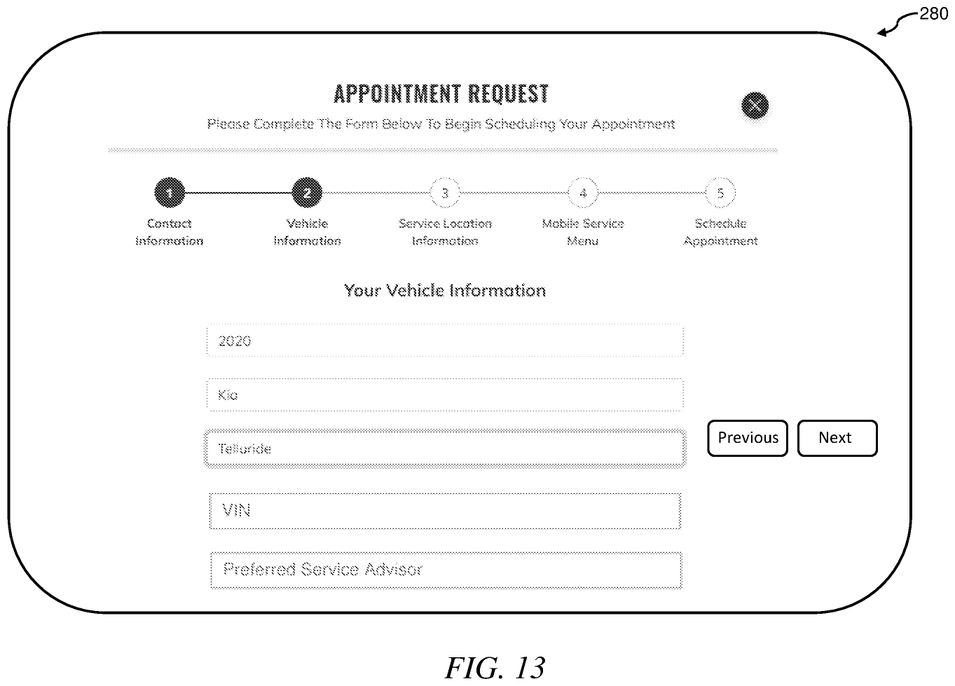

In FIG. 13, a second remote service request user interface 280 provides for the owner (or representative) to enter information regarding their vehicle that is to be serviced such as make, model, year of the vehicle, and VIN if available.

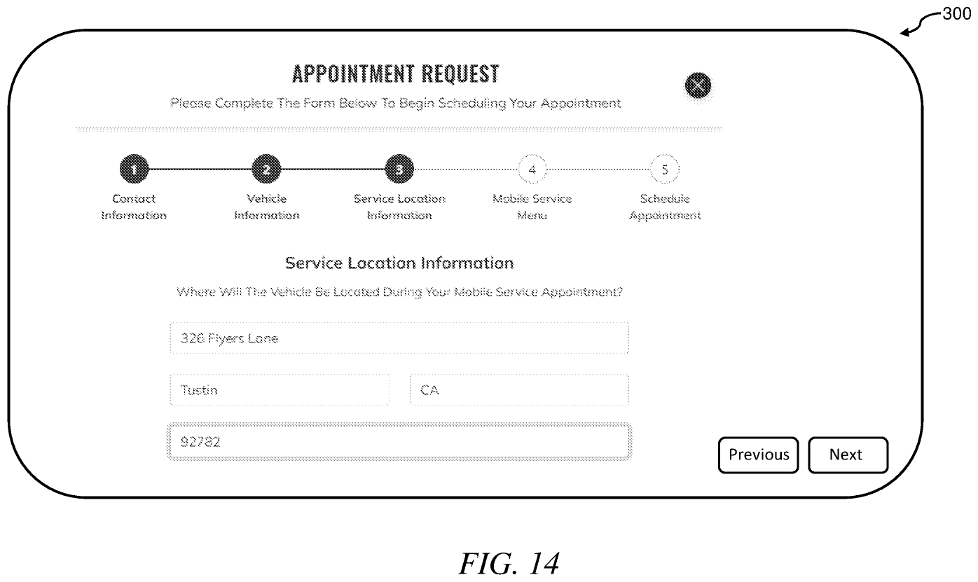

In FIG. 14, a third remote service request user interface 300 provides for the owner (or representative) to enter information regarding the location at which the vehicle is to be serviced. This is the location at which the mobile technician or driver will find the vehicle (e.g., street, city, zip code) and is not required to be the owner's home address, for example, a work address.

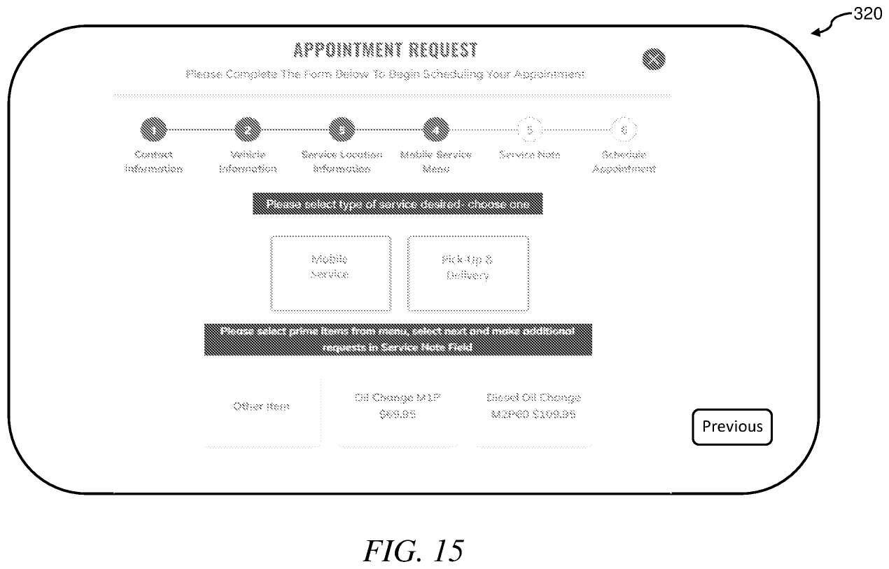

In FIG. 15, a fourth remote service request user interface 320 provides for the owner (or representative) to select one or more services for the vehicle. The fourth remote service request user interface 320 relates to the services selected for the particular service center. For example, the fourth remote service request user interface 320 shown allows for the selection of an oil change, cabin filter, air filter, or a package of all three, but does not allow selection of a tire rotation or car wash as those services are not enabled by the service center.

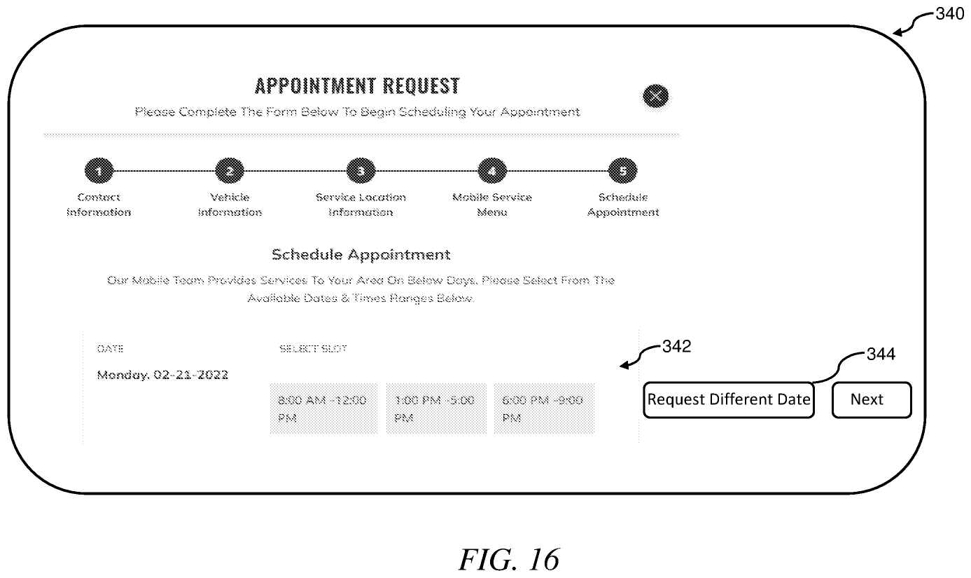

In FIG. 16, a fifth remote service request user interface 340 provides for the owner (or representative) to select one timeslot for the requested services. The fifth remote service request user interface 340 relates to the timeslots and dates administrated for the service center. For example, the fifth remote service request user interface 340 shown allows for the selection of any of three timeslots 342 on the following Monday. If the owner desires a different time other than the three presented, the owner selects the icon 344 for “request a different date”.

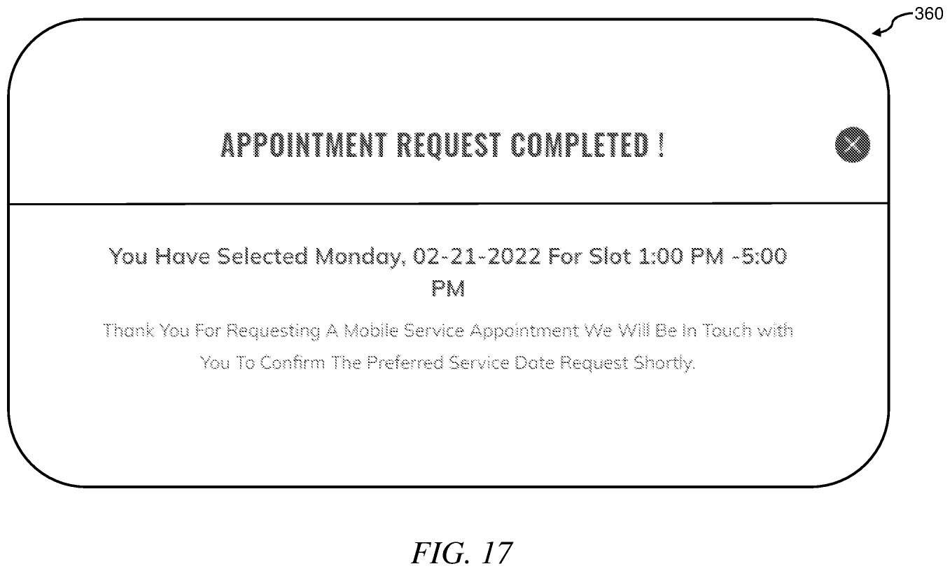

In FIG. 17, a sixth remote service request user interface 360 displays the selected timeslot for the requested services. Note that by setting the timeslot, for example, to a three-hour or four-hour interval, the system for providing remote services has the ability to dynamically adjust the order of appointments during the timeslot to optimize the travel route of the mobile technician/driver within the respective zone or region. For example, if the mobile technician/driver is at the first appointment location and it is determined that there is a severe traffic delay in reaching the second appointment, the system for providing remote services will dynamically reroute the mobile technician/driver to an alternate appointment (for example, the originally scheduled third appointment) and then move the second appointment to now be the third appointment, assuming the traffic delay has abated.

If, in the fifth remote service request user interface 340, the owner desires a different time other than the three presented and the owner selects the icon 344 for “request a different date,” the seventh remote service request user interface 380 is presented allowing the owner to request a specific date for the requested service. Upon making the date selection, the eighth remote service request user interface 400 is presented indicating that a manual scheduling operation will be performed and may or may not result in an appointment on the requested date, typically resulting in a call to the owner to negotiate an available date.

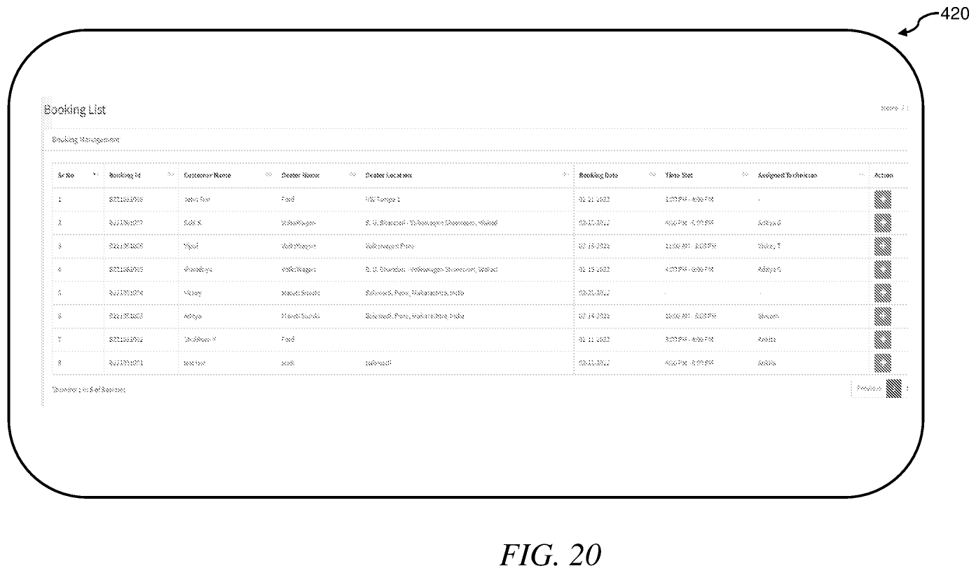

Referring to FIGS. 20 through 23, administrative user interfaces 420, 440, 460, and 480 of the system for providing remote services are shown. The administrative user interfaces 420, 440, 460, and 480 provide views of scheduling, status, and activities completed. In FIG. 20, a first administrative user interface 420 list of all scheduled service requests along with assigned mobile technician/driver is presented. It is anticipated that there are many pages in the first administrative user interface 420 as there are likely more than eight scheduled service requests.

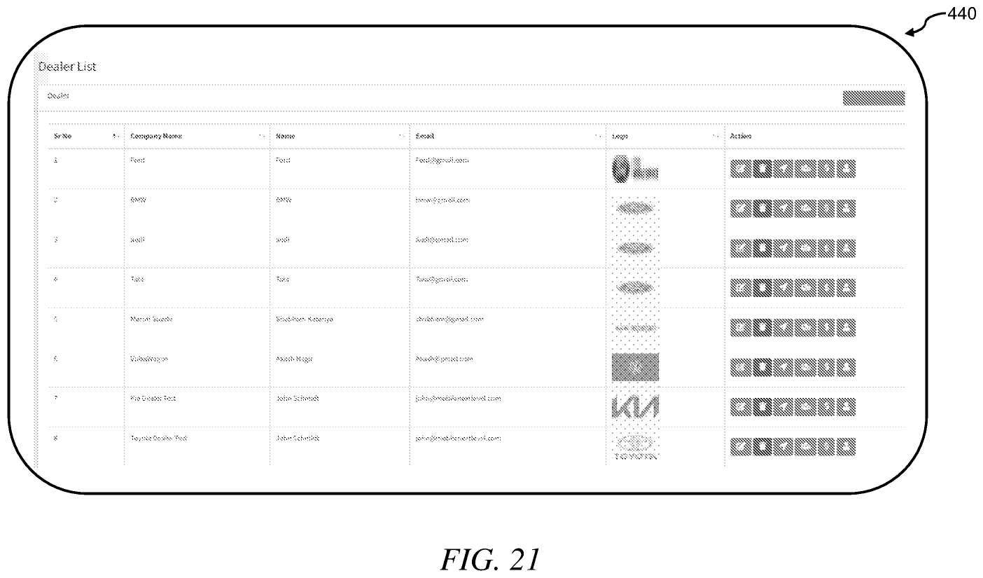

In FIG. 21, a second administrative user interface 440 list of all current service centers (e.g., “Dealers”) is presented. It is also anticipated that there are many pages in the second administrative user interface 440 as there are likely more than eight service centers.

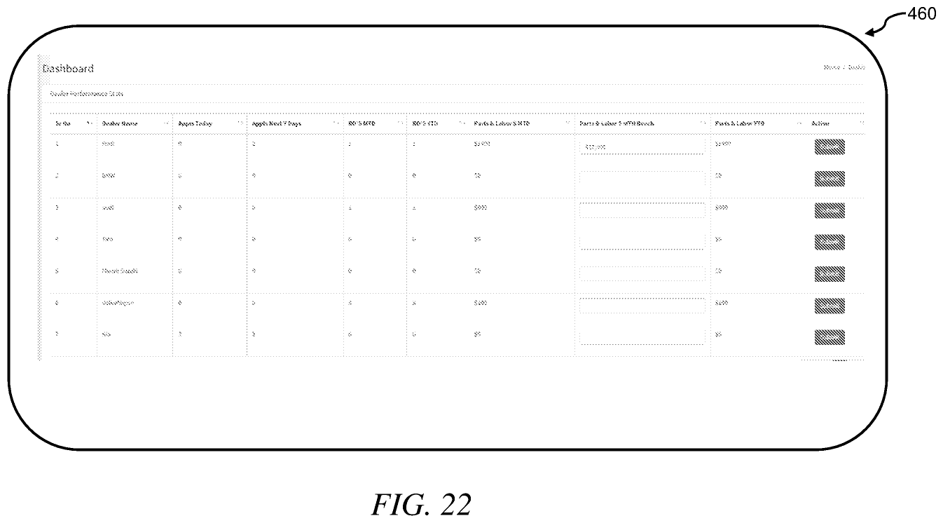

In FIG. 22, a third administrative user interface 460 listing month-to-day or year-to-day status of all current service centers (e.g., “Dealers”) is presented. It is also anticipated that there are many pages in the third administrative user interface 460 as there are likely more than eight service centers. The third administrative user interface 460 provides insight into the progress of the remote service operations.

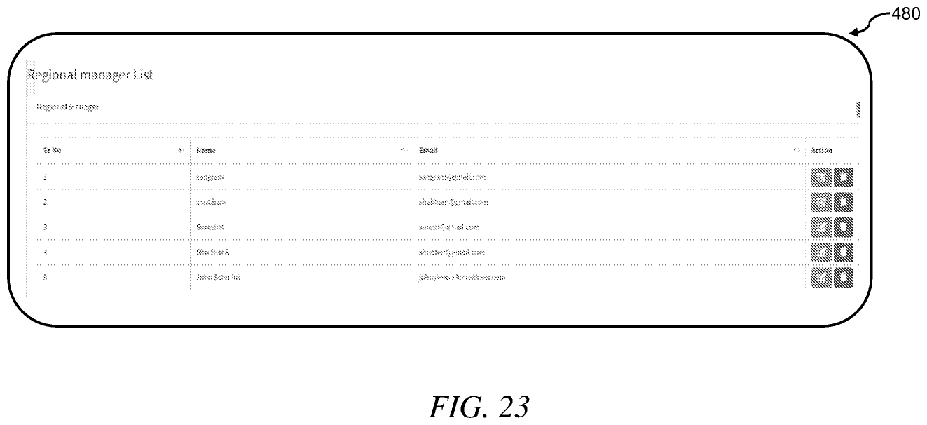

In FIG. 23, a fourth administrative user interface 480 listing regional managers is presented.

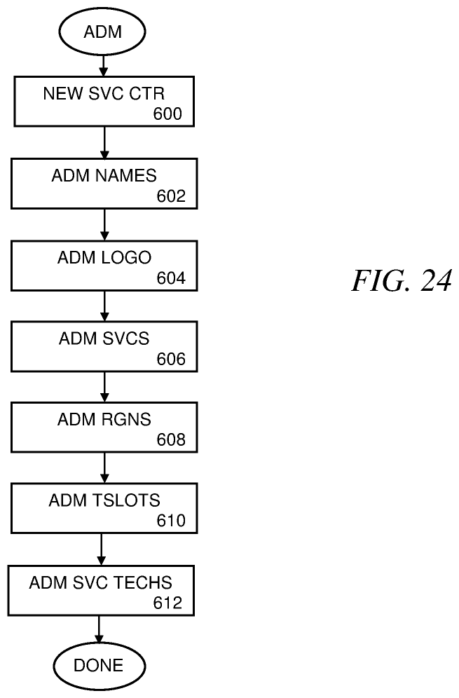

Referring to FIG. 24, an administration flow chart of a typical computer system is shown. Flow begins when a new service center is added 600. Various names are administered 602, for example, names of the dealership and names of the vehicles sold/serviced at the dealership. Logos of the makers of the vehicles sold/serviced and logos of the dealer are administered/added 604. The types and costs of remote services are administered 606, for example, oil changes at a cost of $59.95. The geographic regions are administered 608. Although not required, in some embodiments, geographic regions 900 are administered, typically in quadrants centering on the service center and expanding outwards in a radius of service. An example of an exemplary division of zip codes into zones or geographic regions 900 of the system for providing remote services is shown in the map of geographic regions 900 of FIG. 27. In this, the zip codes that are serviced by the dealership are divided into zone-1 910, zone-2 912, zone-3 914, and zone-4 916. Each zone 910/912/914/916 shown on the map of geographic regions 900 includes the days of the week and time frames in which remote service is available in that zone 910/912/914/916. For example, remote service and pick-up/return is only available on Monday, Wednesday, and Friday from 1:00 PM to 5:00 PM in zone-1 910.

For scheduling, zip codes are added to each geographic region so that when an owner makes an appointment entering the zip code at which the vehicle will be, it is determined in which quadrant the vehicle will be located. Timeslots are established 610 for each of the quadrants, typically one day of the week per quadrant and typically two or three time periods per day of the week. The mobile technicians/drivers are administered 612, adding names, phone numbers, email addresses, and status for each mobile technician/driver.

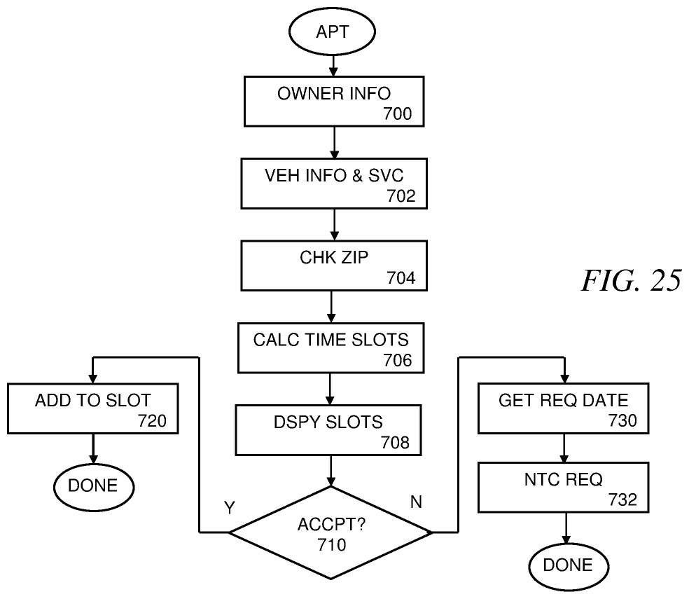

Referring to FIG. 25, a scheduling flow chart of a typical computer system is shown. This is how the system processes a new appointment made by an owner. The owner information is gathered 700, including contact information. The vehicle information and service desired is gathered 702, including the location of the vehicle where the service will be performed. The zip code is extracted from the location information 704 and is used to calculate one or more timeslots 706 that are associated with that zip code. The available timeslot(s) is displayed 708 to the owner. If the owner accepts 710 one of the available timeslots, the owner/vehicle/service is added 720 to the selected timeslot. If the owner does not accept 710 one of the available timeslots and, instead, requests a different time/date, the preferred date is obtained 730 (e.g., by displaying a calendar and the owner selecting a date) and the preferred date is saved and a notice is generated 732. In this, it is assumed that a manual operation is performed to determine a time on the preferred date or a phone call is made to the owner to renegotiate a date/time.

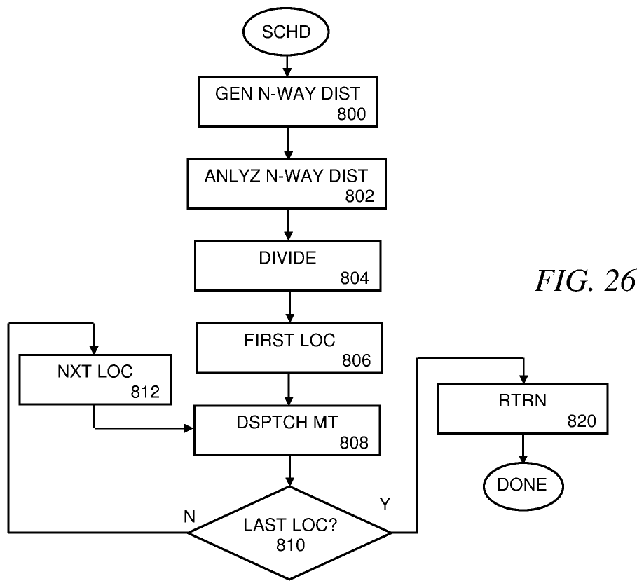

Referring to FIG. 26, a timeslot scheduling flow chart of a typical computer system is shown. This is how the system processes appointments for a particular timeslot. First, for each vehicle location in the current timeslot, a weighted distance is determined 800 for all other vehicle locations in the current timeslot using mapping software and, optionally, local traffic data. For example, if there are three vehicles scheduled in the current timeslot, then the driving time is calculated between the first vehicle and the second vehicle, the second vehicle and the third vehicle, and the first vehicle and the third vehicle, as well as the driving time from the origin of the mobile technician/driver and each of the vehicles. Next, the results of the driving times are analyzed 802 to determine the optimal sequence of vehicle locations to be visited by the mobile technician/driver. Now, if there are multiple mobile technicians/drivers available, the optimal sequence is divided 804 between each of the mobile technicians/drivers.

Now the first location is determined 806 for each mobile technician/driver. Note as it is assumed that each service operation varies by vehicle and type of service, the flow presented assumes the same service or only one mobile technician/driver for clarity and simplicity reasons.

The mobile technician/driver is dispatched to the location 808 and performs the requested service(s). If this is not the last location 810 for the mobile technician/driver, the next location 812 is determined and the mobile technician/driver is dispatched 808 to the next location 812 until the last location 810 is encountered, at which time the mobile technician/driver returns 820 (e.g., to the service center). Note that in some embodiments, after each service is performed by the mobile technician/driver, the steps 800-808 are performed for the remaining locations that are to be serviced by that mobile technician/driver in case traffic conditions have changed so that travel time is optimized for the mobile technician/driver.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction, and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A method of providing remote services, the method comprising:
(a) determining a set of vehicles to be serviced within a timeslot and within a zone of locations;
(b) analyzing a location of each vehicle in the set of vehicles to determine a next vehicle in the set of vehicles to be serviced and a set of services to be performed on the next vehicle;
(c) selecting an available mobile technician from a set of mobile technicians;
(d) establishing a data connection to a mobile technician device that is assigned to the available mobile technician and communicating with the mobile technician device to dispatch the available mobile technician to the next vehicle to perform the set of services at the location of the next vehicle;
(e) removing the next vehicle from the set of vehicles to be serviced in the timeslot; and
(f) until all vehicles in the set of vehicles to be serviced have been assigned to one of the available mobile technician, repeating steps b-e.

2. The method of claim 1, wherein, prior to determining the set of vehicles to be serviced, administering the zone of locations by clustering a set of zip codes.

3. The method of claim 1, wherein, prior to determining the set of vehicles to be serviced, administering a least one timeslot for each zone of the locations.

4. The method of claim 1, wherein, prior to determining the set of vehicles to be serviced, establishing data connections to one or more owner devices and receiving remote service requests from each of the one or more owner devices, each of the remote service requests including a vehicle location that includes a zip code and a timeslot.

5. The method of claim 1, wherein the selecting the available mobile technician from the set of mobile technicians includes matching a skill of the available mobile technician with the set of services to be performed on the next vehicle.

6. A system for providing remote service for vehicles, the system comprising:
a server computer, the server computer connected to a data network, the server computer being configured with at least one timeslot and zone of locations pair;
a plurality of mobile technician devices, each mobile technician device assigned to a mobile technician/driver and each mobile technician device connected to the server computer through the data network;
a plurality of owner devices, each owner device of the plurality of owner devices selectively connected to the server computer through the data network;
the server computer receiving a plurality of remote service requests from the plurality of owner devices, each request including a location of a vehicle to be serviced, the location including a zip code, and each request including a timeslot;
before each timeslot and zone of locations pair, and until all remote service requests for that timeslot and zone of locations pair are dispatched, the server computer assigning a next remote service request in that timeslot and zone of locations pair to a mobile technician/driver and the server computer sending details of the next remote service request to a mobile technician device assigned to the mobile technician/driver through the data network;
the mobile technician/driver visiting the location of the vehicle for remote services; and
the mobile technician/driver performing services included in the next remote service request.

7. The system of claim 6, wherein the zone of locations comprises a cluster of zip codes.

8. The system of claim 6, wherein the timeslot comprises a date and time range.

9. The system of claim 6, wherein the assigning of the next remote service request in that timeslot and zone of locations pair to the mobile technician/driver includes matching a skill of the mobile technician/driver with a set of services included in the next remote service request.

10. The system of claim 6, wherein the mobile technician/driver performing the services included in the next remote service request includes the mobile technician/driver transporting the vehicle to be serviced to a service center where the services are performed and returning the vehicle to the location of the vehicle.

11. A computer-readable storage medium storing instructions that, when executed by a server computer, cause the server computer to perform a process comprising:
establishing, via one or more network interfaces, a first communication channel between the server computer and one or more owner devices and receiving a remote service request from each of the one or more owner devices;
combining all remote service requests for a timeslot and zone; and
for each remote service request for the timeslot and the zone:
establishing, via the one or more network interfaces, a communication channel between the server computer and a mobile technician device; and
sending the each remote service request for the timeslot and the zone to the mobile technician device.

12. The computer-readable storage medium storing instructions of claim 11, that, when executed by the server computer, cause the server computer to further perform the process comprising:
the mobile technician device is selected from a set of mobile technician devices by matching a skill of an available mobile technician associated with the mobile technician device with a set of services to be performed in the remote service request.

13. The computer-readable storage medium storing the instructions of claim 11, that, when executed by the server computer, cause the server computer to perform the process comprising:
combining all remote service requests for the timeslot and the zone includes clustering a set of zip codes in the zone.

14. The computer-readable storage medium storing the instructions of claim 11, wherein each of the remote service requests includes a timeslot and a vehicle location that includes a zip code.
